(19) United States
(12) Patent Application Publication
(10) Pub. No.: US 2017/0054673 A1
(43) Pub. Date: Feb. 23, 2017

(54) METHOD AND DEVICE FOR ESTABLISHING A COMMUNICATION

(71) Applicant: Orange, Paris (FR)

(72) Inventors: Ghislain Moncomble, Plestin les Greves (FR); Helene Cartier, Trebeurden (FR)

(21) Appl. No.: 15/307,685

(22) PCT Filed: Apr. 17, 2015
(86) PCT No.: PCT/FR2015/051046

§ 371 Date: Oct. 28, 2016

(30) Foreign Application Priority Data
Apr. 29, 2014 (FR) 1453897

(51) Int. Cl. H04L 12/58; H04M 3/42; H04L 29/12

(52) U.S. Cl. CPC H04L 51/30; H04L 61/1594; H04M 3/42059; H04W 88/02

(57) ABSTRACT

A method and a device for establishing a communication sent by a recipient terminal in response to a first communication sent by a sender terminal. The method includes reception by the recipient terminal of a message comprising at least one contact address relating to the sender terminal user. The received message also includes at least one piece of validity information associated with the contact address. The received validity information is stored in association with the received contact address. Following the detection of a user interaction requesting establishment of a second communication in response to the first communication, the recipient terminal selects, as a function of the at least one received piece of validity information, a contact address from a group of contact addresses comprising at least the received contact address and sends a request for establishment of the second communication to the selected contact address.

### CROSS-REFERENCE TO RELATED APPLICATIONS

This application is a Section 371 National Stage application of International Application No. PCT/FR2015/051046, filed Apr. 17, 2015, the content of which is incorporated herein by reference in its entirety, and published as WO 2015/166160 on Nov. 5, 2015, not in English.

### FIELD OF THE DISCLOSURE

The invention lies in the field of communications networks.

### BACKGROUND OF THE DISCLOSURE

When a user is subscribed to a Voice over IP service with a communication network operator, he/she has a first identity associated with a first terminal for using the Voice over IP service from the first terminal connected to the communication network.

It is possible for the user to install a communication application on a second terminal associated with a second user identity in order to use the Voice over IP service which is provided by the communication network operator from the second terminal.

For example, the first terminal is a fixed terminal and the second terminal is a mobile terminal or smartphone associated with a second identity. The second terminal is connected to another communication network and the second identity associated with the second terminal is provided by an operator of the other communication network.

Thus, said communication application installed on the second terminal associated with the second identity enables the user of the second terminal to send and receive communications from the first identity associated with the first terminal.

However, when the user uses said communication application installed on the second terminal for sending a communication request to a third terminal belonging to another user, during the reception of the communication request, the user of the third terminal sees the first identity of the user of the second terminal appear and not the second identity associated with the second terminal. The first identity may be different from the second identity. The user of the third terminal may then not recognize the first identity. Or else the first identity may not be stored in the address book of the third terminal and the third terminal then displays a message such as “identity unknown”. The user of the third terminal may then not respond to the communication request received.

In addition, if the user of the third terminal wishes to call back the user of the second terminal sending the communication request, the callback is made to the first sending identity of the communication request and not to the second terminal used to send the communication request. The user sending the communication request may then not be in the vicinity of the first terminal associated with the first identity, or miss the callback if the communication application installed on the second terminal is off.

The same problem arises when the second terminal is a terminal temporarily loaned to the user of the first terminal, e.g. because the first terminal is faulty, or the battery of the first terminal is discharged or else the first terminal has been stolen. When the user of the first terminal uses the second terminal for sending a communication to a third terminal, he/she may not change the identity of the terminal sending the communication request and he/she risks not being able to receive a callback request originating from the third terminal.

Document US20070010264A1 describes a method when sending a communication request to a third terminal of coincidentally sending rich contact information containing all the telephone numbers of the user sending the communication request. The contact information is stored in the address book of the third recipient terminal of the communication request.

In the event of the third terminal calling back the user that has initially sent the communication request, the user of the third terminal must then choose one of the numbers recorded in association with the user sending the initial communication request. The user of the third terminal does not know whether the number chosen makes it possible to reach the user sending the initial communication request in an optimum way.

Document US20090310765A1 makes it possible when sending a communication request from a second terminal to a third terminal, to present the third terminal with a name and a telephone number associated with the user sending the communication request which are different from the name and the telephone number associated with the second terminal used to send the communication request. Thus, a user who sends a communication request from a second terminal that he/she does not normally use may present his/her own identity instead of presenting the second identity associated with the second terminal used for sending the communication request.

Providing the third terminal with an identity and a contact address associated with the user sending the communication request is only performed here for presenting the user of the third terminal with information for identifying the user sending the communication request when he/she uses a second terminal different from his/her usual terminal.

Later, when the user of the third terminal wishes to call back the user sending the communication request, the user of the third terminal does not know from which contact address the user sending the communication request is reachable. For example, if the user of the third terminal uses the contact address stored in his/her address book in association with the identity of the user sending the communication request, the communication request sent by the user of the third terminal is sent to the usual terminal of the sending user. However, the sending user may not be reachable on his/her usual terminal, e.g. due to a battery problem or loss of his/her terminal. According to another example, if the user of the third terminal uses the contact address of the second terminal used to send the initial communication request, e.g. by sending a communication request from an entry in the call log of the third terminal, the communication request is sent to the second terminal sending the initial communication request. However, the user sending the initial communication request may no longer be in the vicinity of the second terminal used to send the initial communication request, e.g. because it is a terminal on casual loan.

### SUMMARY

An exemplary embodiment of the present application provides a method for establishing a communication sent by a recipient terminal in response to a first communication sent by a sending terminal, including a step of reception by the recipient terminal of a message including at least one contact address relating to the user of the sending terminal. The received message further includes at least one piece of validity information associated with the contact address. The method for establishing a communication further includes:
a step of storing the received validity information in association with the contact address,
following the detection of a user interaction requesting the establishment of a second communication in response to the first communication, a step of selecting according to said at least one piece of received validity information a contact address from a group of contact addresses including at least the received contact address,
a step of requesting the establishment of the second communication to the selected contact address.

Correspondingly, the invention concerns a device for establishing a communication capable of implementing such a method. More precisely, such a device includes means of receiving a message including at least one contact address relating to the user of the sending terminal. The device for establishing a communication further includes:
means of storing in association with the contact address, a piece of validity information associated with the contact address, the validity information being included in the received message,
means of detecting a user interaction requesting the establishment of a second communication in response to a first communication sent by a sending terminal,
means of selecting according to said at least one piece of received validity information, a contact address from a group of contact addresses including at least the received contact address, said means of selecting being activated following said detected user interaction,
means of sending a request for the establishment of the second communication to the selected contact address.

The invention thus provides a method for establishing a communication in which a contact address sent during the reception of a first communication is stored on the recipient terminal of the communication in association with a piece of validity information indicating, for example, a validity duration of the contact address and/or a validity time range (hourly range, days, etc.).

The contact address may be sent simultaneously with the first communication or after the first communication.

According to a first example, if the sending terminal is a terminal loaned to the sending user, the user of the sending terminal sends at the same time as the first communication a contact address, e.g. a telephone number of his/her own terminal, at which the user of the sending terminal will be reachable together with a piece of validity information associated with this contact address, e.g. the time from which the user of the sending terminal may be contacted via this contact address.

As a variant of this first example, the contact address may correspond to the contact address of the sending terminal. The validity information may then correspond to the duration during which the user of the sending terminal may be contacted via the contact address of the sending terminal.

According to a second example, the sending terminal is a terminal of the sending user, e.g. a mobile terminal, on which a communication application is installed enabling the user of the sending terminal to send and receive communications from an identity associated with a third terminal of the sending user, e.g. his/her home terminal. According to this second example, the contact address of the sending terminal corresponds to the address associated with the third terminal since the communication application installed on the sending terminal makes it possible to emulate a communication sent from the third terminal. The contact address included in the message may correspond to the contact address associated with the sending terminal, e.g. the mobile phone number or MSISDN (for Mobile Station International Subscriber Directory Number) associated with the sending terminal when the sending terminal is a mobile terminal connected to a mobile communication network. As a variant, the contact address included in the message may correspond to any other contact address indicated by the user of the sending terminal.

During a request for the establishment of a second communication by the recipient user, the recipient terminal selects according to the validity information the contact address at which the user of the sending terminal may be contacted. The method according to the invention thus makes it possible to increase the chances that the user of the sending terminal responds to the second communication when the user of the recipient terminal requests the establishment of the second communication.

The invention described above applies to any type of communications sent by the sending terminal: telephone calls, videophone calls, SMS (for Short Message Service), MMS (for Multimedia Message Service) messages, etc.

Contact address here means an address enabling a terminal to be contacted via a communication network for establishing a communication. Such a contact address may be a telephone number provided by a communication network operator, an e-mail address, a URI (for Uniform Resource Identity) address, an IP address, etc.

The various embodiments or features mentioned below may be added independently or in combination with one another, to the steps of the method for establishing a communication as defined above.

The various embodiments or features mentioned below may be added independently or in combination with one another, to the features of the device for establishing a communication as defined above.

According to a particular embodiment of the invention, a piece of information identifying the user of the sending terminal is received during the step of reception of at least one contact address relating to the user of the sending terminal, and said identifying information is reproduced visually on the recipient terminal during the reception of the first communication.

According to this particular embodiment of the invention, the user of the recipient terminal is informed of the identity of the user sending the first communication received by the recipient terminal. This particular embodiment of the invention is particularly advantageous in the case where the recipient terminal reproduces the contact address associated with the terminal sending the first communication and the user of the recipient terminal does not know this address or this address is not recorded in the address book associated with the recipient terminal, the recipient terminal may not then associate the contact address associated with the sending terminal and an identity of a user stored in the address book associated with the recipient terminal.

According to another particular embodiment of the invention, the received contact address and the received validity information are stored in a log of communications received by the recipient terminal, in association with a piece of information relating to the reception of the first communication stored in said log.

This particular embodiment of the invention is advantageous when the user of the recipient terminal chooses to request the establishment of a second communication to the sending terminal from the log of communications received, e.g. when the user of the recipient terminal sees that he/she has received a new communication. For example, in the case of a telephone communication, the new communication may be a missed call or a call to which the user has responded.

According to another example, in the case of an SMS or MMS communication, the new communication is a message that the user of the recipient terminal has not yet read.

According to another particular embodiment of the invention, the method for establishing a communication includes:
a step of verifying the presence of the received contact address in the address book associated with the recipient terminal,
in the case of a positive verification, the received validity information is stored in association with the received contact address in the address book associated with the recipient terminal.

This particular embodiment of the invention is advantageous in the case where the sending terminal is a terminal loaned to the user. The user of the sending terminal may thus indicate via the validity information the time from which the user of the recipient terminal may reach him/her as usual from the contact address stored in the address book of the recipient terminal and which corresponds to the received contact address.

According to another particular embodiment of the invention, a piece of information identifying the user of the sending terminal is received during the step of reception of at least one contact address relating to the user of the sending terminal. The method of establishing a communication includes a step of verifying the presence of the identifying information in the address book associated with the recipient terminal. In the case of a positive verification, the received validity information is stored in association with the received contact address and in association with the identifying information in the address book associated with the recipient terminal.

This particular embodiment of the invention is advantageous in the case where the received contact address is not stored in the address book associated with the recipient terminal but a piece of information identifying the user of the sending terminal is already stored in the address book of the recipient terminal in association with another contact address, for example. Thus, at the time of the request for establishing a second communication to the user of the sending terminal from the selection of the information identifying the user of the sending terminal in the address book of the recipient terminal, the recipient terminal has the received contact address and the associated validity information.

According to another particular embodiment of the invention, the received contact address is deleted from the recipient terminal when the received validity information indicates that the received contact address is no longer valid.

This particular embodiment of the invention prevents the user of the recipient terminal from attempting to establish a communication with the user of the sending terminal via a contact address at which the user of the sending terminal is no longer reachable. For example, in the case where the sending terminal is a loaned terminal, the user of the sending terminal may use it for a certain duration, e.g. fifteen minutes, and no longer be in the vicinity of the sending terminal thereafter. This particular embodiment of the invention may also be used to save the resources of the recipient terminal.

According to another particular embodiment of the invention, during the step of reception of at least one contact address relating to the user of the sending terminal, a piece of context information is received.

This particular embodiment of the invention thus enables the user of the sending terminal to indicate to the user of the recipient terminal the reason why the user of the sending terminal is sending a contact address to the recipient terminal. The context information may be contained in a text field in which the user of the sending terminal has inserted a comment. The context information may also be contained in a standardized field of a message including the contact address. Such a standardized field may take a predetermined value selected by the user of the sending terminal from a group of predetermined values such as “mobile stolen, faulty mobile, battery discharged, call from abroad, package used up, etc.”.

The invention also concerns a method for providing contact information in association with the sending of a first communication sent by a sending terminal to a recipient terminal. The method of providing contact information includes:
a step of obtaining at least one contact address relating to the user of the sending terminal,
a step of obtaining at least one piece of validity information associated with the contact address obtained,
a step of inserting into a message validity information in association with the contact address obtained,
a step of sending said message by the sending terminal, to the recipient terminal.

Correspondingly, the invention concerns a device capable of implementing the method of providing contact information. Such a device includes:
means of obtaining at least one contact address relating to the user of the sending terminal,
means of obtaining at least one piece of validity information associated with the contact address obtained,
means of inserting into a message validity information in association with the contact address obtained,
means of sending said message by the sending terminal, to the recipient terminal.

The method and device for providing contact information enable the user of the sending terminal to provide a contact address and a piece of validity information associated with this contact address to the user of the recipient terminal. The validity information associated with the contact address enables the recipient terminal to know over what interval of time, or up to when the user of the sending terminal may be contacted via the contact address provided.

The various embodiments or features mentioned below may be added independently or in combination with one another, to the steps of the method for providing contact information defined above.

The various embodiments or features mentioned below may be added independently or in combination with one another, to the features of the device for providing contact information defined above.

According to a particular embodiment of the invention, the message is sent following the reception of an indication of no response from the recipient terminal to the first communication.

This particular embodiment of the invention makes it possible to optimize the resources of the communication network on which the contact information is transmitted. Indeed, in this particular embodiment of the invention, the contact address is only transmitted to the recipient terminal if the user of the recipient terminal does not respond to the first communication.

The invention also concerns a terminal including a device for establishing a communication according to any one of the embodiments previously described.

The invention also concerns a terminal including a device for providing contact information according to any one of the embodiments previously described.

The invention also concerns a message for providing contact information transmitted between a terminal sending a first communication to a recipient terminal. The message includes at least one contact address relating to the user of the sending terminal and at least one piece of validity information associated with the contact address. The validity information associated with the contact address enables the recipient terminal to select a contact address according to said at least one piece of validity information and to send a request for the establishment of a second communication to the selected contact address, in response to the first communication.

According to a particular embodiment of the invention, the message for providing contact information further includes a piece of information identifying the user of the sending terminal or a piece of context information.

In a particular embodiment of the invention, the various steps in the method for establishing a communication and in the method for providing contact information are implemented by computer program instructions.

Accordingly, the invention is also aimed at computer programs on an information medium, since these programs are likely to be implemented respectively in a terminal or more generally in a computer, these programs respectively comprising instructions suitable for the implementation of the various steps in the method for establishing a communication or the various steps in the method for providing contact information that have just been described.

These programs may use any programming language, and be in the form of source code, object code, or intermediate code between source code and object code, such as in a partially compiled form, or in any other desirable form.

The invention is also aimed at an information medium capable of being read by a computer, and comprising instructions in a computer program such as that mentioned above.

The information medium may be any entity or device capable of storing the program. For example, the medium may comprise a means of storage, such as a ROM, e.g. a CD-ROM or a microelectronic circuit ROM, or a magnetic or electronic recording means, e.g. a USB stick or a hard disk.

Moreover, the information medium may be a transmissible medium such as an electrical or optical signal, which may be routed via an electrical or optical cable, by radio or by other means. The program according to the invention may in particular be downloaded on an Internet type network.

Alternatively, the information medium may be an integrated circuit incorporating the program, the circuit being suitable for executing or for being used in the execution of the method for establishing a communication or in the execution of the method for providing contact information in question.

The advantages of the computer program comprising instructions suitable for implementing the various steps in the method for establishing a communication or the various steps in the method for providing contact information are identical to those described in relation to the method in question according to any one of the particular embodiments mentioned above.

### BRIEF DESCRIPTION OF THE DRAWINGS

Other advantages and features of the invention will appear more clearly on reading the following description of particular embodiments of the invention, given as simple, illustrative and non-restrictive examples, and accompanying drawings, in which:

FIG. 1 illustrates an environment for implementing the invention according to a particular embodiment of the invention.

FIG. 2 schematically illustrates steps in the method for providing contact information according to a particular embodiment of the invention.

FIG. 3 schematically illustrates steps in the method for establishing a communication according to a particular embodiment of the invention.

FIG. 4 illustrates a device capable of implementing the method for establishing a communication according to a particular embodiment of the invention.

FIG. 5 illustrates a device capable of implementing the method for providing contact information according to a particular embodiment of the invention.

FIGS. 6A, 6B and 6C illustrate a message for providing contact information according to particular embodiments of the invention.

### DETAILED DESCRIPTION OF ILLUSTRATIVE EMBODIMENTS

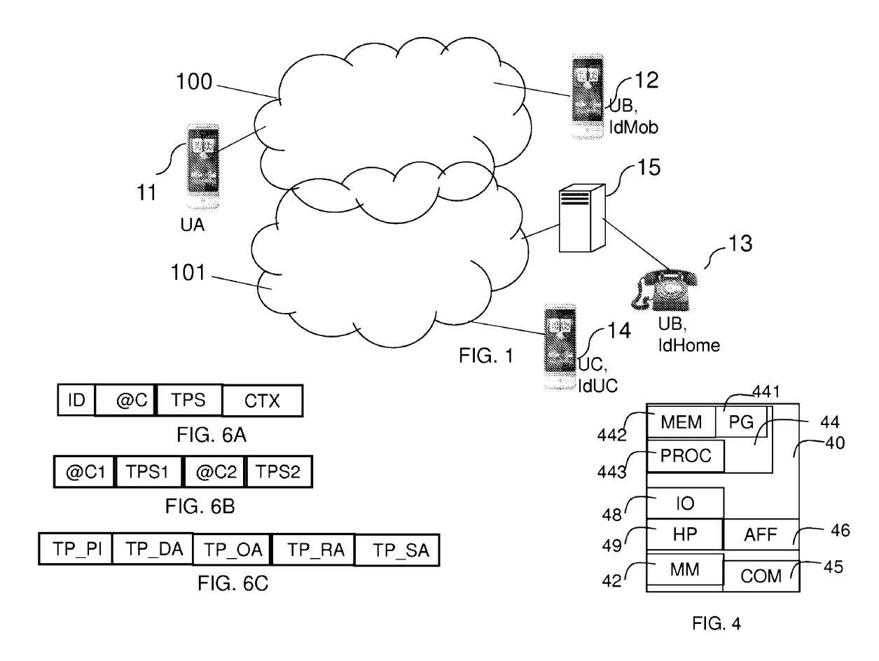

FIG. 1 illustrates an environment for implementing the invention according to a particular embodiment of the invention. The environment in FIG. 1 includes a group of communication networks 100 and 101 to which terminals 11, 12, 13, 14, and a home gateway 15 are connected.

The communication network 100 corresponds, for example, to a mobile communication network of the GSM, EDGE, 3G, 3G+ or 4G etc. type. It may be implemented by an RCS or any other mobile network architecture. The communication network 100 may correspond to multiple communication networks of different communication operators interconnected via access points (not represented).

The communication network 101 corresponds, for example, to an IP communication network that may be implemented by an IMS (for IP Multimedia Subsystem) architecture. The communication network 101 is, for example, constructed from a Public Switched Telephone Network (abbreviated to PSTN) infrastructure. The communication network 101 may correspond to multiple communication networks of different communication operators interconnected via access points (not represented).

The communication networks 100 and 101 are interconnected by interconnection servers (not represented). The communication network 100 and the communication network 101 make it possible to exchange data and to establish communications between terminals connected to the communication network 100 or to the communication network 101.

The terminals 11, 12 and 14 may be any type of terminals for establishing a telephone or videophone communication, such as a mobile phone, smartphone, tablet, TV connected to a communication network, or a personal computer on which a telephony application, also called a softphone, is installed.

In the example described here, the terminal 11 is a smartphone associated with a user UA. The terminal 11 is connected to the communication network 100 and can send and receive any type of communications, via the communication network 100.

In the example described here, the terminal 14 is a smartphone associated with a user UC. The terminal 14 is connected to the communication network 100 and can send and receive any type of communications, via the communication network 100.

In the example described here, the terminal 12 is a smartphone associated with a user UB. The terminal 12 is connected to the communication network 100 and can send and receive any type of communications, via the communication network 100. For this, the terminal 12 is registered in the communication network 100 with a public identity IdMob associated with the user UB. The public identity IdMob corresponds, for example, to a mobile phone number. In order to communicate with the user UB on the terminal 12, the terminal 11 uses the public identity IdMob for reaching the terminal 12.

In the environment described in relation to FIG. 1, the user UB also has a terminal 13 corresponding, for example, to the fixed terminal in his/her home. The terminal 13 is connected to a home gateway 15 enabling the terminal 13 to access the communication network 101.

The home gateway 15 is registered in the communication network 101 with a public identity IdHome provided by the operator of the communication network 101. Such a public identity corresponds, for example, to a telephone number. The home gateway 15 manages the signaling and data streams relating to calls sent to or from the public identity IdHome. The home gateway 15 transmits the streams relating to a sent or received communication to the terminals connected to the home gateway 15, notably the terminal 13.

In the example described here, the operator of the communication network 101 has provided the user UB with a communication application HOME_COM intended to be installed on a terminal of the user UB connected to a communication network. The communication application HOME_COM is, for example, installed on the terminal 12 of the user UB. The communication application HOME_COM enables the user UB from terminal 12:
to establish communications to other terminals using the identity IdHome associated with the terminal 13 in his/her home,
and to receive on the terminal 12 communications sent by other terminals to the identity IdHome.

Thus, the communication application HOME_COM enables the user UB to use the identity IdHome associated with the terminal 13 from the terminal 12.

However, when the user UB sends a communication request or sends a message, e.g. an SMS or MMS, using the communication application HOME_COM from the terminal 12 to another terminal, e.g. the terminal 11, the identity of the terminal sending the communication request or the message which is presented on the terminal 11 is the identity IdHome associated with the terminal 13. But the user of the terminal 11 may not recognize the identity IdHome and not respond to the communication request or not respond to the message. The address book associated with the terminal 11 may, for example, contain the identity IdMob associated with the terminal 12 of the user UB and not the identity IdHome of the user UB.

In addition, when the user UA of the terminal 11 wishes to call back the user UB e.g. from an entry in the call log indicating a missed call sent by the identity IdHome, the communication request sent by the terminal 11 is transmitted to the identity IdHome and not to the identity IdMob. But the user UB may have switched off the communication application HOME_COM on the terminal 12 and not be in the vicinity of the terminal 13. The user UB then risks missing the communication request sent by the terminal 11.

Similarly, if the user of the terminal 11 wishes to respond to a message received from the user UB via the identity IdHome, the response to the message will be transmitted to the identity IdHome.

Similar problems arise when the user UB uses a terminal other than the terminal 12 or the terminal 13 for sending a communication, e.g. the terminal 14 of the user UC. For example, the user UC may have temporarily loaned his/her terminal 14 to the user UB, e.g. because the terminal 12 of the user UB has a discharged battery or is faulty, or stolen.

Following the reception by the terminal 11 of a communication from the terminal 12 sent at the initiative of the user UB, if the user of the terminal 11 wishes to call back the user UB from the entry in the call log indicating the reception of the communication, the communication request sent by the terminal 11 will be transmitted to the terminal 14 of the user UC. But the user UB may no longer be in the vicinity of the user UC and the terminal 14. In addition, the communication request sent by the terminal 11 and received by the terminal 14 to the user UB may inconvenience the user UC.

Likewise, if the user of the terminal 11 wishes to respond to a message sent by the user UB from the terminal 14, the response to the message will be transmitted to the terminal 14. The user UB may then not have access to it. In addition, the user UC will receive a message that is not intended for him/her.

According to the first example described above, the terminal 12 implements the method for providing contact information according to a particular embodiment of the invention. At the time of a first communication being sent by the terminal 12 to the terminal 11, the terminal 12 provides the terminal 11 with a contact address relating to the user UB and a piece of validity information associated with this contact address. The first communication sent by the terminal 12 is associated with a sending contact address. The sending contact address is the contact address used for sending the first communication, it corresponds, for example, to the value of the sending address field of a message signaling the first communication. The sending contact address corresponds to the contact address of the terminal 12 or to the contact address associated with the sending communication application of the first communication when the first communication is sent via the application HOME_COM described above.

The contact address provided by the terminal 12 is then an alternative contact address to the sending contact address. The terminal 11 implements the method for establishing a communication according to a particular embodiment of the invention in order to establish a second communication to the user UB by ensuring that the contact address to which the second communication is sent is a contact address that makes it possible to contact the user UB with a high probability. For this, the terminal 11 according to the validity information selects a contact address associated with the user UB.

According to the second example described above, the terminal 14 implements the method for providing contact information according to a particular embodiment of the invention. At the time of a first communication being sent by the terminal 14 to the terminal 11, the terminal 14 thus provides the terminal 11 with a contact address relating to the user UB and a piece of validity information associated with this contact address. Thus, the terminal 11 may implement the method for establishing a communication according to a particular embodiment of the invention.

For more clarity in the rest of the description, the contact address provided by the terminal sending the first communication according to the method for providing contact information and received by the recipient terminal of the first communication will be termed the alternative contact address.

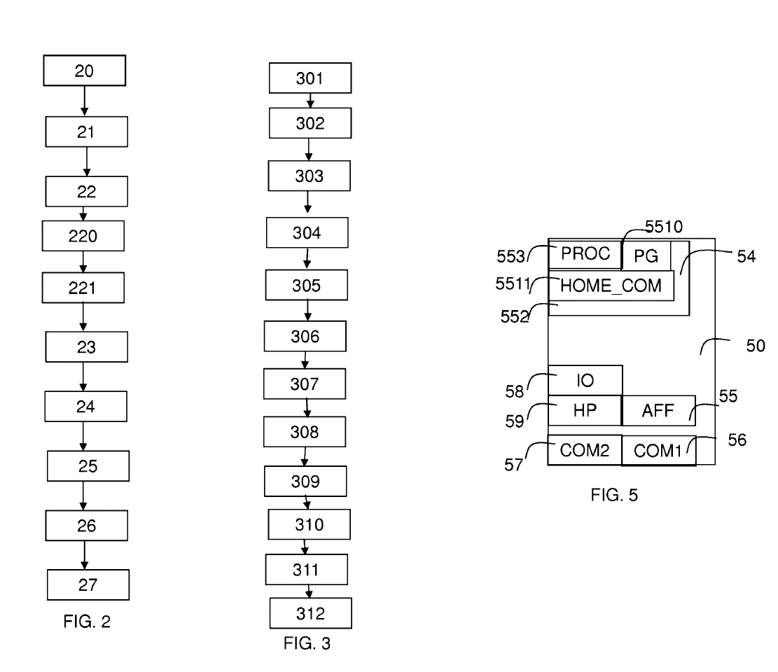

FIG. 2 schematically illustrates steps in the method for providing contact information according to a particular embodiment of the invention. The method for providing contact information is described according to a first example of implementation in which the user UB sends a communication request to the terminal 11 in FIG. 1. The method for providing contact information may be independently implemented by the terminal 12 or the terminal 14. Subsequently, the method for providing contact information is described according to an implementation by the terminal 12.

In a step 20, the user UB of the terminal 12 wishes to establish a communication to the terminal 11 from the application HOME_COM installed on the terminal 12. For this, he/she selects in an address book of the terminal 12, the telephone number associated with the terminal 11 or dials this telephone number on the keyboard of the terminal 12. In step 20, the user UB selects a functionality of the application HOME_COM dedicated to the invention and making it possible to provide an alternative contact address and a piece of validity information associated with sending the communication. In step 20, the terminal 12 then displays on the screen an interface enabling the user UB to provide an alternative contact address.

When the method for providing contact information is implemented by the terminal 14, it may be implemented in the form of an application APP downloaded from a platform for providing mobile applications and installed on the terminal 14. This application APP may be an additional component of communication applications previously installed on the terminal 14 such as the telephone communication application in circuit mode, or VoIP, or the SMS, MMS, etc. messaging application. As a variant, the application APP is an independent application running in cooperation with the communication applications of the terminal 14. The implementation of the method for providing contact information by the application APP is identical to that performed by the application HOME_COM described below.

In step 21, the terminal 12 obtains a first alternative contact address. For example, this first alternative contact address corresponds to the telephone number IdMob associated with the terminal 12. The user UB may dial the telephone number from the keyboard in a dedicated field of the interface displayed by the terminal 12. As a variant, the terminal 12 may propose by default the telephone number IdMob to the user UB who validates the proposed telephone number by clicking on a validation key of the terminal 12 or a validation key displayed on the interface. According to another variant, the terminal 12 may propose multiple telephone numbers predefined by the user UB in a menu. The user UB selects one of the predefined telephone numbers and validates by clicking on the validation key.

In step 22, the terminal 12 obtains a piece of validity information associated with the first alternative contact address obtained in step 21. The validity information may correspond to a validity duration, such as 5 minutes, 10 minutes, 1 hour. The validity information may also correspond to an hourly time range including a validity start date and time and a validity end date and time. The validity information may otherwise include a date and time from which the contact address is valid and a parameter indicating an indefinite duration. Thus, the alternative contact address is considered as still valid. Conversely, the validity information may include a date and time indicating the date and time from which the alternative contact address is not valid and a parameter indicating that the alternative contact address is valid up to the indicated date and time. Thus, the alternative contact address is valid from the reception of this alternative contact address and temporarily up to the indicated date and time.

The validity information may be provided by the user UB by completing a field of the interface dedicated to the validity information. As a variant, the terminal 12 may also propose by default a maximum or minimum validity duration and a parameter indicating whether the alternative contact address is valid up to the indicated validity duration or from the indicated validity duration.

In the example described here, the user UB selects a piece of validity information including:
as the validity start date, the day's date,
as the validity start time, the present instant plus one hour,
as the validity end date, the day's date and,
as the validity end time, the validity start time plus two hours.

In a step 23, the terminal 12 records the alternative contact address obtained in step 21 and the validity information obtained in step 22.

According to a particular embodiment of the invention, in a step 220, the terminal 12 obtains a piece of information identifying the user UB. The information identifying the user UB may be provided by the user UB by completing a field provided for this purpose in the interface displayed by the terminal 12. This particular embodiment is advantageous in the case where the user UB uses the terminal 14 of the user UC instead of the terminal 12.

As a variant, the terminal 12 obtains the information identifying the user UB from a parameter stored on the terminal 12 in association with the alternative contact address provided by the user UB. The user UB has, for example, previously defined the identifying information during the configuration of the application HOME_COM. According to another variant, the terminal 12 detects that the alternative contact address provided in step 21 corresponds to the contact address associated with the terminal 12 and identifies the identity of the user UB associated with the terminal 12, e.g. from the data stored in the SIM (for Subscriber Identity Module) card of the terminal 12. The identifying information obtained is stored in the course of step 23 in association with the validity information.

According to another particular embodiment of the invention, in a step 221, the terminal 12 obtains a piece of context information corresponding, for example, to the reason for which the user UB is providing an alternative contact address. According to this particular embodiment of the invention, the interface may display a drop-down menu in which contexts are displayed in word form. For example, the menu includes contexts such as: faulty mobile, mobile stolen, battery discharged, traveling abroad, blocked package, etc.

As a variant, the user UB may complete a field dedicated to the context information. In step 23, the terminal 12 records the context information obtained in association with the alternative contact address obtained in step 21.

In a step 26, the terminal 12 inserts the data stored in step 23 into a message M. The message M is, for example, a message OPTIONS according to the SIP (for Session Initiation Protocol) protocol. As a variant, the message M may be an SMS or MMS message.

The portion of the message M relating to the invention is illustrated by FIG. 6A according to a particular embodiment of the invention.

FIG. 6A presents a data field @C into which the terminal 12 inserts the alternative contact address obtained in step 21 and a data field TPS into which the terminal 12 inserts the validity information obtained in step 22.

According to a particular embodiment of the invention, FIG. 6A also includes a data field ID into which the terminal 12 inserts the information identifying the user UB obtained in step 220.

According to another particular embodiment of the invention, FIG. 6A also includes a data field CTX into which the terminal 12 inserts the context information obtained in step 221.

In a step 27, the terminal 12 sends the message M to the terminal 11 in parallel with a step 24 of sending a communication request by the terminal 12 to the terminal 11. Such a communication request is, for example, sent in the form of an INVITE message according to the SIP protocol.

According to a particular embodiment of the invention, the message M is sent after the sending of the communication request sent to the terminal 11 in step 24. According to this particular embodiment of the invention, the message M is sent only in the case where the communication request sent in step 24 is not accepted by the terminal 11. In this case, in a step 25, the terminal 12 receives a no response message from the terminal 11 or from a communication network to which the terminal 11 is connected. Such a no response message is, for example, sent in the form of a message 4xx according to the SIP protocol.

As a variant, in step 25, the terminal 12 determines that the communication request was sent in step 24 for a predetermined duration, e.g. 20 seconds, and that no message of acceptance of the communication request was received by the terminal 12. Such an acceptance message is, for example, a 200 OK message according to the SIP protocol. According to this variant, following the detection by the terminal 12 of the non-acceptance of the communication request by the terminal 11, the terminal 12 sends the message M in the course of step 26.

According to another particular embodiment of the invention, the message M may be sent in the form of an SMS message. In this particular embodiment of the invention, the reception of the message M may then be offset with respect to the reception of the communication request sent in step 24. This offset does not matter in the case where the message M is sent when the terminal 12 determines that the communication request is not accepted by the terminal 11.

According to a particular embodiment of the invention, the user UB may provide the terminal 11 with multiple alternative contact addresses. For this, steps 21, 22 and 23 are iterated for each alternative contact address that the user UB wishes to provide.

For example, in the iteration of step 21, the terminal 12 obtains a second contact address. According to this example, the user UB provides the telephone number IdHome associated with the application HOME_COM in the interface field dedicated to providing an alternative contact address. Then, in the iteration of step 22, the terminal 12 obtains a piece of validity information associated with the second alternative contact address including a validity duration equal to one hour.

In the iteration of step 23, the second alternative contact address and the associated validity information are recorded on the terminal 12.

In step 26, the terminal 12 inserts into a message M′ the data stored in step 23. The portion of the message M′ relating to the particular embodiment of the invention described here is illustrated in FIG. 6B.

FIG. 6B shows:
a data field @C1 into which the terminal 12 inserts the first alternative contact address IdMoB,
a data field TPS1 into which the terminal 12 inserts the validity information associated with the first alternative contact address,
a data field @C2 into which the terminal 12 inserts the second alternative contact address IdHome,
a data field TPS2 into which the terminal 12 inserts the validity information associated with the second alternative contact address.

The message M′ is, for example, an OPTIONS message according to the SIP protocol. In step 27, the terminal 12 sends the message M′ to the terminal 11 in parallel with sending the communication request to the terminal 11 in step 24.

The method for providing contact information is now described according to a second example of implementation in which the user UB sends an SMS message to the terminal 11.

The method for providing contact information may be independently implemented by the terminal 12 or the terminal 14. Subsequently, the method for providing contact information is described according to an implementation by the terminal 12.

According to this second example, steps 20 through 23 are similar to steps 20 through 23 described in relation to the first example of implementation.

In step 24, the user UB composes a text message to be inserted into a Payload field of an SMS message M″ to be sent to the terminal 11.

In step 26, the terminal 12 inserts the alternative contact address obtained in step 21 into the message M″. The message M″ is illustrated by FIG. 6C. FIG. 6C shows:
a data field TP_PI corresponding to the standardized field TP-Protocol Identifier indicating the type of the SMS message, into which the terminal 12 inserts a value specific to the invention. Standardized field here means a field of an SMS message as defined by standard TS23.040 of the 3GPP (for Third Generation Partnership Project) standardization group.
a data field TP_DA corresponding to the standardized field TP-destination-address indicating the telephone number of the recipient terminal of the SMS, into which the terminal 12 inserts the telephone number of the terminal 11.
a data field TP_OA corresponding to the standardized field TP-originating-address indicating the telephone number of the terminal sending the SMS, into which the terminal 12 inserts, according to the particular embodiment of the invention described here, the first alternative contact address obtained in step 21, or as a variant, the identifying information obtained in step 220. According to the particular embodiment of the invention described here, the field TP-OA will be used by the terminal 11 for displaying the identity of the terminal sending the SMS M″.
a data field TP-RA corresponding to the standardized field TP-recipient-address indicating the telephone number of the terminal sending an SMS Submitted of the Replace Short Message type in the case of an SMS which deletes or replaces a previously received SMS. According to the particular embodiment of the invention described here, the terminal 12 inserts the alternative contact address obtained in step 21 into this data field. According to the particular embodiment of the invention described here, the field TP-RA will be used by the terminal 11 as the destination address in the case of the terminal 11 sending a response message to the message M″.

According to another particular embodiment of the invention, the message M″ also includes a new data field TP-SA into which the terminal 12 inserts the alternative contact address obtained in step 21. The field TP-SA is used by the terminal 11 as the destination address in the case of the terminal 11 sending a response message to the message M″. According to this other particular embodiment of the invention, the standardized field TP-RA is not used.

In the example described in relation to FIG. 6C, the validity information is predetermined and corresponds, for example, to a duration of 10 minutes. In this example, the validity information is not transmitted in the message M″ but it is deduced from the message M″ by the method for establishing a communication described later in relation to FIG. 3.

In step 27, the terminal 12 sends the message M″ to the terminal 11.

According to a particular embodiment of the invention, the message M″ includes multiple alternative contact addresses. According to this particular embodiment of the invention, the message M″ takes the form of multiple chained SMS messages. For this, the first SMS message of the chain includes a data field TP-MMS (for TP-More Message to Send) the value of which indicates the number of the SMS message in the chain. Each SMS message in the chain includes in the field TP-RA an alternative contact address obtained in step 21. Each SMS message in the chain is then associated with a different validity duration to apply to the alternative contact address provided in the field TP-RA. For example, the alternative contact address included in the first SMS message is valid for the first 5 minutes following the reception of the SMS message chain. Then, the alternative contact address included in the second SMS message is valid for the 5 minutes following the end of the validity of the first contact address, etc.

FIG. 3 schematically illustrates steps in the method for establishing a communication according to a particular embodiment of the invention. The method for establishing a communication is, for example, implemented by the terminal 11. The method for establishing a communication is implemented in response to a first communication sent by a sending terminal, such as the terminal 12 or the terminal 14 according to any of the particular embodiments of the invention described in relation to FIG. 2.

In a step 301, the terminal receives a first communication sent by a sending terminal associated with a sending contact address. When the first communication received by the terminal 11 is sent by the terminal 12 via the application HOME_COM, the sending contact address is the identity IdHome of the terminal 13.

When the first communication received by the terminal 11 is sent by the terminal 14, the sending contact address is the identity IdUC of the terminal 14.

When the first communication is received by the terminal 11, the terminal 11 records the sending contact address in association with a piece of information indicating the reception of the first communication in a communications log containing the communications received by the terminal 11, such as a received calls log, or a missed calls log or even a received messages log.

In the case where the first communication is a communication request accepted by the terminal 11, e.g. a telephone call taken off-hook by the user UA, the information indicating the reception of the first communication is an entry in the received calls log including the date and time of reception of the first communication and the sending contact address.

In the case where the first communication is a communication request not accepted by the terminal 11, the information indicating the reception of the first communication is an entry in the missed calls log including the date and time of reception of the first communication and the sending contact address.

In the case where the first communication is a message, e.g. an SMS or MMS message, the information indicating the reception of the first communication is an entry in the received messages log including the received message itself.

In a step 302, the terminal 11 receives a message including at least one alternative contact address. Such a message may correspond to a message illustrated according to any one of the particular embodiments of the invention described in relation to FIG. 6A, 6B or 6C.

The message received in step 302 also includes a piece of validity information associated with each alternative contact address included in the message.

According to a particular embodiment of the invention, the message received in step 302 includes a piece of information identifying the user UB, e.g. the information contained in the field ID illustrated in FIG. 6A or the information contained in the field TP-OA illustrated in FIG. 6C. In a step 303, the identifying information included in the received message is reproduced visually by the terminal 11 when the terminal 11 displays the reception of the first communication in step 301.

In a step 304, the terminal 11 records each alternative contact address contained in the message received in step 302, and the validity information associated with each alternative contact address in the log of communications received or missed by the terminal 11, in association with the information indicating the reception of the first communication.

According to a particular embodiment of the invention, when the message received in step 302 corresponds to the message M″ described in relation to FIG. 6C, the validity information is predetermined and obtained from the content type in the field TP-PI of the message M″. For example, the field TP-PI indicates that the message M″ is a message in conformity with the invention and that the validity information associated with the alternative contact address included in the field TP-RA or TP-SA is 10 minutes with respect to the reception of the message M″.

According to a particular embodiment of the invention, in a step 305, the terminal 11 verifies in the address book associated with the terminal 11, the presence of at least one piece of alternative contact information contained in the message received in step 302.

In the case of a positive verification, i.e. if at least one piece of alternative contact information contained in the message received in step 302 is present in the address book associated with the terminal 11, in a step 306, the validity information associated with this alternative contact information is recorded in the address book associated with the terminal 11 in association with the alternative contact address. According to this particular embodiment of the invention, when the message received in step 302 contains more than one alternative contact address, the other alternative contact addresses are also recorded with their respective validity information in the address book associated with the terminal 11 in association with the alternative contact address already present.

According to another particular embodiment of the invention, when the message received in a step 302 includes a piece of information identifying the user UB, the terminal 11 verifies in the course of step 306 whether the information identifying the user UB is present in the address book associated with the terminal 11. In the case where the information identifying the user UB is present in the address book associated with the terminal 11, the terminal 11 records each contact address contained in the message received in step 302 and their respective validity information in the address book associated with the terminal 11 in association with the identifying information already present.

In a step 307, the terminal 11 detects a user interaction of the user UA on the terminal 11 requesting the establishment of a second communication in response to the first communication request. For example, the user UA selects the entry corresponding to the reception of the first communication in the communications received log or in the missed communications log. According to another example, the user UA selects in the received messages log, the SMS or MMS message received in step 301. According to another example, the user UA selects the entry in the address book associated with the terminal 11 corresponding to the information identifying the user UB.

Following step 307, the terminal 11 selects in the course of a step 308 a recipient contact address of the second communication. In the course of step 308, the terminal 11 determines a valid contact address from the contact addresses recorded in association with the entry selected by the user UA in step 307.

For this, the terminal 11 compares the validity information of each contact address recorded and the present instant.

For example, in the case where the message received in step 302 corresponds to the message M′ described in relation to FIG. 6B and the user UB requests a second communication in a time interval of less than one hour with respect to the reception of the first communication, the terminal 11 selects the second alternative contact address @C2. If the user UB requests a second communication in a time interval of more than one hour with respect to the reception of the first communication and less than three hours with respect to the reception of the first communication, the terminal 11 selects the first alternative contact address @C1. If the user UB requests a second communication in a time interval of more than three hours with respect to the reception of the first communication and therefore in a time interval which does not correspond to any received and valid alternative contact address, the terminal 11 selects a default contact address.

For example, in the case where the user UA selects an entry in a communications log in step 307, the default contact address is the sending contact address of the first communication.

According to yet another example, in the case where the user UA selects an entry in the address book associated with the terminal 11 corresponding to the information identifying the user UB, the default contact address is the contact address already present in the address book associated with the terminal 11.

In the case where the message received in step 302 corresponds to the message M described in relation to FIG. 6A and the user UB requests a second communication in a time interval of more than one hour with respect to the reception of the first communication and less than three hours with respect to the reception of the first communication, the terminal 11 selects the first alternative contact address @C. If the user UB requests a second communication in a time interval of less than one hour or in a time interval of more than three hours with respect to the reception of the first communication, the terminal 11 selects a default contact address, e.g. the sending contact address.

In the case where the message received in step 302 corresponds to the message M″ described in relation to FIG. 6C and the user UB requests a second communication in a time interval of less than 10 minutes with respect to the reception of the first communication, the terminal 11 selects the alternative contact address contained in the field TP-RA or TP-SA according to the embodiment of the invention. When the user UB requests a second communication in a time interval of more than 10 minutes with respect to the reception of the first communication, the terminal 11 selects the contact address contained in the field TP-OA of the message M″.

According to a particular embodiment of the invention, in a step 309, the terminal 11 verifies that each alternative contact address examined in step 308 is valid. When the validity information associated with an alternative contact address indicates that the alternative contact address is no longer valid, the alternative contact address is deleted from the terminal 11 in a step 310. A contact address is no longer valid, for example, because the validity duration has been exceeded or the validity time interval has been exceeded. The alternative contact address may be logically deleted by setting a parameter associated with the alternative contact address to false. Thus, the recording of the alternative contact address is preserved in the memory of the terminal 11 but the alternative contact address can no longer be selected for establishing a new communication. This variant is particularly useful for keeping track of the destination of the second communication sent.

According to another variant, the record of the alternative contact address is deleted from the memory of the terminal 11 thus optimizing the resources of the terminal 11.

According to a particular embodiment of the invention, a piece of context information is included in the message received in step 302. The context information is associated with an alternative contact address included in the message received in step 302. According to this particular embodiment of the invention, the context information is recorded in the course of step 304 by the terminal 11 in association with the alternative contact address to which it relates. The context information makes it possible to indicate to the user UB the reason for which the user UA has sent an alternative contact address and a piece of validity information associated with this alternative contact address. In the course of a step 311, if the terminal 11 in step 308 has selected an alternative contact address associated with a piece of context information, the terminal 11 visually reproduces the context information associated with the alternative contact address. Step 311 of reproducing the context information may be performed simultaneously with step 312 which is described below.

In a step 312, the terminal 11 sends a request for establishing a second communication to the contact address selected in step 308. For example, when the second requested communication is a VoIP communication, the request for establishing a second communication may correspond to an INVITE message according to the SIP protocol. According to another example, when the second requested communication is an SMS or MMS communication, the request for establishing a second communication corresponds to a standard SMS or MMS message.

FIG. 4 illustrates a device capable of implementing the method for establishing a communication according to a particular embodiment of the invention.

The device 40 includes a processing module 44, notably including a storage module 442, e.g. a memory (MEM), and a processing unit 443 provided, for example, with a microprocessor (PROC). The processing unit 443 is controlled by a computer program (PG) 441 implementing the method for establishing a communication as described in relation to FIG. 3. On initialization, the code instructions of the computer program 441 are, for example, loaded into memory (MEM), before being executed by the processor (PROC) of the processing unit 443.

The processor (PROC) of the processing unit 443 implements the steps in the method for establishing a communication sent by a recipient terminal, such as the terminal 11 in FIG. 1, in response to a first communication sent by a sending terminal, such as the terminal 12 in FIG. 1, according to the instructions of the computer program 441. The processor (PROC) of the processing unit 443 notably implements:
a step of reception of a message including at least one alternative contact address relating to the user of the sending terminal, and at least one piece of validity information associated with the alternative contact address,
a step of storing the validity information in association with the alternative contact address,
following the detection of a user interaction requesting the establishment of a second communication in response to the first communication, a step of selecting according to said at least one piece of validity information a contact address from a group of contact addresses including at least the received alternative contact address,
a step of requesting the establishment of the second communication to the selected contact address.

The device 40 also comprises communication means 45. The communication means are, for example, implemented by a communication module (COM). The communication module (COM) notably enables the device 40 to be connected to the communication network 100 in FIG. 1 and to establish communications via the communication network 100 in FIG. 1. Notably, the communication module (COM) enables the device 40 to receive the first communication sent by the sending terminal, to receive a message for providing contact information as described notably in relation to FIGS. 6A, 6B and 6C and to send a request for the establishment of the second communication.

The device 40 also comprises a second storage module (MM) 42 for storing the alternative contact address and the validity information associated with the alternative storage address included in the received message.

According to a particular embodiment of the invention, the storage module (MM) may be identical to the storage module 442 included in the processing module 44.

According to another particular embodiment of the invention, the storage module (MM) is a memory space external to the device 40, such as a memory space of a server in a communication network.

According to another particular embodiment of the invention, the storage module (MM) is a memory space in a SIM card connected to the device 40.

According to a particular embodiment of the invention, the storage module (MM) is also used to store a piece of context information associated with the alternative contact address included in the received message.

According to another particular embodiment of the invention, the storage module (MM) is also used to store a piece of information identifying the user of the sending terminal associated with the alternative contact address included in the received message.

The device 40 conventionally comprises a sound reproduction and capture module 49, e.g. speakers and a microphone (HP) enabling the device 40 to reproduce and capture an audio stream from a user.

The device 40 comprises a user interaction module 48, e.g. a numeric keypad or a touch interface (IO) enabling a user to interact with the device 40. Notably, the user interaction module 48 enables a user of the device 40 to request the establishment of a second communication.

According to a particular embodiment of the invention, the device 40 comprises a reproduction module 46, e.g. a screen (AFF) notably for reproducing a piece of information identifying the user of the sending terminal or a piece of context information associated with an alternative contact address.

According to a particular embodiment of the invention, the device 40 is included in a terminal, such as a mobile or fixed terminal.

FIG. 5 illustrates a device capable of implementing the method for providing contact information according to a particular embodiment of the invention.

The device 50 includes a processing module 54, notably including a storage module 552, e.g. a memory, and a processing unit 553 provided, for example, with a microprocessor (PROC). The processing unit 553 is controlled by a computer program (PG) 5510 implementing the method for providing contact information as described in relation to FIG. 2. On initialization, the code instructions of the computer program 5510 are, for example, loaded into memory (552), before being executed by the processor (PROC) of the processing unit 553.

The processor (PROC) of the processing unit 553 implements the steps in the method for providing contact information provided in association with the sending of a first communication sent by a sending terminal, such as the terminal 12 in FIG. 1, to a recipient terminal, such as the terminal 11 in FIG. 1, according to the instructions of the computer program 5510. The processor (PROC) of the processing unit 553 notably implements:
a step of obtaining at least one alternative contact address relating to the user of the sending terminal,
a step of obtaining at least one piece of validity information associated with the alternative contact address obtained,
a step of inserting into a message validity information in association with the alternative contact address,
a step of sending said message by the sending terminal, to the recipient terminal.

According to a particular embodiment of the invention, the device 50 also comprises communication means 56. The communication means are, for example, implemented by a communication module (COM1). The communication module (COM1) notably enables the device 50 to be connected to the communication network 100 in FIG. 1 and to establish communications via the communication network 100 in FIG. 1. Notably, the communication module (COM1) enables the device 50 to send via the communication network 100 a first communication and to send via the communication network 100 a message for providing contact information as described notably in relation to FIGS. 6A, 6B and 6C to the recipient terminal.

According to another particular embodiment of the invention, the device 50 also comprises communication means 57. The communication means are, for example, implemented by a communication module (COM2). The communication module (COM2) notably enables the device 50 to be connected to the communication network 101 in FIG. 1 and to establish communications via the communication network 101 in FIG. 1. Notably, the communication module (COM2) enables the device 50 to send a first communication via the communication network 101 and to send via the communication network 101 a message for providing contact information as described notably in relation to FIGS. 6A, 6B and 6C to the recipient terminal. According to this other particular embodiment of the invention, the device 50 comprises an application HOME_COM in the form of a computer program 5511 stored in the storage module 552. When the device 50 is included in the terminal 12 in FIG. 1, the device 50 is associated with an identity IdMob associated with the terminal 12. The identity IdMob is a contact address for establishing communications from the device 50 via the communication network 100. The communication application HOME_COM of the device 50 enables the device 50:
to establish communications to other terminals via the communication network 101 using the identity IdHome associated with the terminal 13 in FIG. 1,
and to receive via the communication network 101 communications sent by other terminals to the identity IdHome.

Thus, the communication application HOME_COM enables the device 50 to use the identity IdHome associated with the terminal 13 in order to establish communications instead of the identity IdMob associated with the terminal 12.

The device 50 conventionally comprises a sound reproduction and capture module 59, e.g. speakers and a microphone (HP) enabling the device 50 to reproduce and capture an audio stream from a user.

The device 50 comprises a user interaction module 58, e.g. a numeric keypad or a touch interface (IO) enabling a user to interact with the device 50.

According to a particular embodiment of the invention, the device 50 comprises a reproduction module 55, e.g. a screen (AFF). The reproduction module 55 is notably used to display an interface on which a user of the device 50 may provide via the user interaction module at least one alternative contact address and at least one piece of validity information associated with the alternative contact address. As a variant, the reproduction module 55 is notably used to display an interface on which a user of the device 50 may validate via the user interaction module a contact address and a piece of validity information proposed by the device 50 and displayed on the interface.

According to a particular embodiment of the invention, the device 50 is included in a terminal, such as a mobile or fixed terminal.

Although the present disclosure has been described with reference to one or more examples, workers skilled in the art will recognize that changes may be made in form and detail without departing from the scope of the disclosure and/or the appended claims.

1. A method for establishing a communication sent by a recipient terminal in response to a first communication sent by a sending terminal, comprising the following acts by the recipient terminal:
reception by the recipient terminal of a message including at least one contact address relating to a user of the sending terminal, and at least one piece of validity information associated with the contact address
storing the received validity information in association with the contact address,
following the detection of a user interaction requesting establishment of a second communication in response to the first communication, selecting according to said at least one piece of received validity information a contact address from a group of contact addresses including at least the received contact address,
requesting establishment of the second communication to the selected contact address.

2. The method for establishing a communication as claimed in claim 1, wherein:
a piece of information identifying the user of the sending terminal is received during the act of reception of at least one contact address relating to the sending user, and
said identifying information is reproduced visually on the recipient terminal during the reception of the first communication.

3. The method for establishing a communication as claimed in claim 1, wherein the received contact address and the received validity information are stored in a log of communications received by the recipient terminal, in association with a piece of information relating to the reception of the first communication stored in said log.

4. The method for establishing a communication as claimed in claim 1, wherein the method includes:
verifying a presence of the received contact address in an address book associated with the recipient terminal,
in the case of a positive verification, the received validity information is stored in association with the received contact address in the address book associated with the recipient terminal.

5. The method for establishing a communication as claimed in claim 1, wherein:
a piece of information identifying the user of the sending terminal is received during the act of reception of at least one contact address relating to the sending user,
the method includes verifying a presence of the identifying information in an address book associated with the recipient terminal,
in the case of a positive verification, the received validity information is stored in association with the received contact address and in association with the identifying information in the address book associated with the recipient terminal.

6. The method for establishing a communication as claimed in claim 1, wherein the received contact address is deleted from the recipient terminal when the received validity information indicates that the received contact address is no longer valid.

7. The method for establishing a communication as claimed in claim 1, wherein during the act of reception of at least one contact address relating to the sending user, a piece of context information is received.

8. A method for providing contact information in association with sending a first communication sent by a sending terminal to a recipient terminal, wherein the method includes:
obtaining at least one contact address relating to a user of the sending terminal,
obtaining at least one piece of validity information associated with the contact address obtained,
inserting into a message validity information in association with the contact address obtained, and
sending said message by the sending terminal, to the recipient terminal.

9. The method for providing contact information as claimed in claim 8, wherein the message is sent following reception of an indication of no response from the recipient terminal to the first communication.

10. A device for establishing a communication in response to a first communication sent by a sending terminal, wherein the device comprises:
means for receiving a message including at least one contact address relating to a user of the sending terminal,
means for storing in association with the contact address, a piece of validity information associated with the contact address, the validity information being included in the received message,
means for detecting a user interaction requesting establishment of a second communication in response to the first communication,
means for selecting according to said at least one piece of received validity information, a contact address from a group of contact addresses including at least the received contact address, said means for selecting being activated following said detected user interaction, and
means for sending a request for the establishment of the second communication to the selected contact address.

11. A device for providing contact information in association with a sending of a first communication sent by a sending terminal to a recipient terminal, wherein the device comprises:
means for obtaining at least one contact address relating to a user of the sending terminal,
means for obtaining at least one piece of validity information associated with the contact address obtained,
means for inserting into a message validity information in association with the contact address obtained,
means for sending said message by the sending terminal, to the recipient terminal.

12. A terminal including the device as claimed in claim 11.

13. A non-transitory computer-readable medium comprising a computer program stored thereon and comprising program code instructions for execution of a method for establishing a communication sent by a recipient terminal in response to a first communication sent by a sending terminal, when the program is executed by a processor of the recipient terminal, wherein the method comprises:
reception by the recipient terminal of a message including at least one contact address relating to a user of the sending terminal, and at least one piece of validity information associated with the contact address
storing the received validity information in association with the contact address,
following the detection of a user interaction requesting establishment of a second communication in response to the first communication, selecting according to said at least one piece of received validity information a contact address from a group of contact addresses including at least the received contact address, and
requesting establishment of the second communication to the selected contact address.

14. (canceled)

15. (canceled)

16. A non-transitory computer-readable medium comprising a computer program stored thereon and comprising program code instructions for execution of a method for providing contact information in association with sending a first communication sent by a sending terminal to a recipient terminal, when the program is executed by a processor of the sending terminal, wherein the method comprises:
obtaining at least one contact address relating to a user of the sending terminal,
obtaining at least one piece of validity information associated with the contact address obtained,
inserting into a message validity information in association with the contact address obtained, and
sending said message by the sending terminal, to the recipient terminal.

17. A terminal including the device as claimed in claim 10.
